(19) United States
(12) Patent Application Publication
(10) Pub. No.: US 2021/0209325 A1
(43) Pub. Date: Jul. 8, 2021

(54) FLEXIBLE CIRCUIT BOARD, ULTRASONIC FINGERPRINT MODULE AND ELECTRONIC DEVICE

(71) Applicant: JIANGXI OUMAISI MICROELECTRONICS CO., LTD., Nanchang (CN)

(72) Inventor: Xuanxuan LIU, Nanchang (CN)

(21) Appl. No.: 17/205,327

(22) Filed: Mar. 18, 2021

Related U.S. Application Data
(63) Continuation of application No. PCT/CN2019/112610, filed on Oct. 22, 2019.

(30) Foreign Application Priority Data
Jul. 17, 2019 (CN) 201921126123.4

(51) Int. Cl. G06K 9/00; H05K 1/18

(52) U.S. Cl. CPC G06K 9/0002; G06F 21/32; H05K 1/189

(57) ABSTRACT

The disclosure discloses a flexible circuit board, an ultrasonic fingerprint module and an electronic device. The flexible circuit board includes a substrate, one first pin and a plurality of second pins. The substrate includes a first connection area and a second connection area connected with the first connection area. The first pin is disposed in the first connection area and the plurality of second pins are disposed in the second connection area. The first pin has a first connection surface away from the substrate. The first pin defines an accommodation space. The accommodation space has an opening on the first connection surface.

### CROSS-REFERENCE TO RELATED APPLICATION(S)

This application is a continuation of International Application No. PCT/CN2019/112610, filed on Oct. 22, 2019, which claims priority to and the benefit of Chinese Patent application No. 201921126123.4, Jul. 17, 2019, the entire disclosures of which are hereby incorporated by reference.

### TECHNICAL FIELD

The disclosure relates to the technical field of electronic devices, in particular to a flexible circuit board, an ultrasonic fingerprint module, and an electronic device.

### BACKGROUND

An electronic device with an ultrasonic fingerprint module is more and more popular with users, due to its accurate collecting of users' fingerprints even when fingers have dirt or oil stains.

In traditional manufacturing of the ultrasonic fingerprint module, an anisotropic conductive film (ACF) is firstly applied to a base plate, and then a part of a flexible circuit board is bonded to the base plate with the ACF (e.g., a first bonding process), for electrical connection with pixel electrodes. In a bonding process, the ACF may overflow to an electrode layer and solidify (e.g., cured). In this way, another part of the flexible circuit board can be bonded to the electrode layer through the solidified ACF (e.g., a second bonding process). However, connection achieved through a secondary bonding of the ACF is not strong enough. In addition, in the secondary bonding process, the ACF accumulated between the flexible circuit board and the electrode layer is not compacted by a pressing head, and there is a gap between the flexible circuit board and a electrode layer, which allows external air or water vapor easily enter into the gap and affect the electrical connection between the flexible circuit board and the electrode layer, thus affecting electrical connection reliability of the ultrasonic fingerprint module.

### SUMMARY

The disclosure provides a flexible circuit board, an ultrasonic fingerprint module, and an electronic device.

The flexible circuit board provided in an implementation includes a substrate, one first pin, and multiple second pins. The substrate includes a first connection area and a second connection area connected with the first connection area. The first pin is disposed in the first connection area and the multiple second pins are disposed in the second connection area. The first pin has a first connection surface away from the substrate. The first pin defines an accommodation space. The accommodation space has an opening on the first connection surface.

In this implementation, by defining the accommodation space in the first pin, part of an anisotropic conductive film (ACF) can be filled into the accommodation space during a process of bonding the first pin to an electrode layer. In this way, the ACF formed between the first connection surface and the electrode layer has a small thickness, thus ensuring that conductive particles in the ACF can be electrically connected with both the first pin and the electrode layer at the same time, and further ensuring electrical connection stability between the first pin and a first portion of the ACF.

In addition, when the ACF between the first connection surface and the electrode layer has a small thickness, no gap will be generated between the flexible circuit board and the electrode layer, thus ensuring that no external water vapor or air will enter.

In addition, by defining the accommodation space in the first pin, a contact area between the first pin and the first portion is increased, so that electrical connection stability between the first pin and the first portion can be improved.

In an implementation, the first pin has a second connection surface. The second connection surface is disposed opposite to the first connection surface. The accommodation space extends through the second connection surface. In this way, the accommodation space has a large volume so that more ACF can be accommodated in the accommodation space during bonding of the first pin to the electrode layer, thereby reducing the thickness of the ACF between the first connection surface and the electrode layer, and ensuring that the conductive particles in the ACF can be electrically connected to the first pin and the electrode layer at the same time.

In an implementation, the first pin has a circumferential side surface. The circumferential side surface is connected between the first connection surface and the second connection surface. The accommodation space extends through at least part of the circumferential side surface, that is, the circumferential side surface has an opening of the accommodation space. In this way, when the first pin is bonded to the first portion, part of the ACF can flow out in a direction away from the first pin through the opening of the circumferential side surface, thereby further reducing the thickness of the ACF disposed between the first connection surface and the electrode layer.

In an implementation, the accommodation space has a planar groove side wall. The groove side wall has an included angle relative to the first connection surface. The included angle is greater than 90°. In this way, compared with an included angle of 90°, in this implementation, the included angle is set to be greater than 90° so that a surface area of the groove side wall of the accommodation space is larger. Therefore, on one hand, during bonding of the first pin of the flexible circuit board to the electrode layer, more ACF can be accommodated in the accommodation space, thereby reducing the thickness of the ACF disposed between the first connection surface and the electrode layer; on the other hand, the contact area between the first pin and the first portion is increased, thereby improving the electrical connection stability between the first pin and the first portion.

In addition, compared with an included angle which is less than or equal to 90°, in this implementation, by setting the included angle to be greater than 90°, difficulty in preparing the accommodation space at the first pin can be reduced.

In an implementation, the accommodation space has a cambered groove side wall, and the cambered groove side wall is concave in a direction away from a center of the accommodation space. In this way, the surface area of the groove side wall of the accommodation space is larger. Therefore, on one hand, during bonding of the first pin of the flexible circuit board to the electrode layer, more ACF can be accommodated in the accommodation space, thereby reducing the thickness of the ACF disposed between the first connection surface and the electrode layer, and on the other hand, the contact area between the first pin and the first portion is increased, thereby improving the electrical connection stability between the first pin and the first portion.

In an implementation, the accommodation space has multiple accommodation spaces arranged in an array. In this way, the accommodation space has a large total volume, that is, more ACF can be accommodated in the accommodation space, thereby reducing the thickness of the ACF between the first connection surface and the electrode layer. In addition, the contact area between the first pin and the first portion can also be increased, thereby improving the electrical connection stability between the first pin and the first portion.

The ultrasonic fingerprint module provided in an implementation includes a base plate, multiple pixel electrodes, a piezoelectric element, an electrode layer, an ACF, a fingerprint chip, and the flexible circuit boards described in any of above implementations. The base plate has a first surface. The multiple pixel electrodes are disposed on the first surface. The piezoelectric element is disposed on surfaces of the multiple pixel electrodes away from the first surface and covers the multiple pixel electrodes. The electrode layer is at least partially disposed on a surface of the piezoelectric element away from the first surface. The ACF includes a first portion and a second portion connected with the first portion, and the first portion is disposed on the electrode layer and the second portion is partially disposed on the first surface. The first connection surface of the flexible circuit board is attached to the first portion, and the first portion is partially received in the accommodation space, the first pin is electrically connected with the electrode layer through the first portion, and the multiple second pins are disposed in the second portion and electrically connected with the multiple pixel electrodes through the second portion. The fingerprint chip is mounted on the flexible circuit board and electrically connected between the first pin and the second pins.

In this implementation, the first pin defining the accommodation space is bonded to the first portion so that part of the ACF can be disposed in the accommodation space. In this way, the ACF formed between the first connection surface and the electrode layer has a small thickness, thus ensuring that conductive particles in the ACF can be electrically connected with both the first pin and the electrode layer at the same time, and further ensuring the electrical connection stability between the first pin and the first portion and thus a stable electrical connection of the ultrasonic fingerprint module.

In an implementation, the electrode layer includes a body part and an extension part connected with the body part. A thickness of the body part in a first direction is larger than that of the extension part in the first direction. The first direction is a direction directed from the base plate to the piezoelectric element. The first portion is disposed on the extension part.

In this implementation, the first pin of the flexible circuit board is electrically connected with the extension part, so that the flexible circuit board and the electrode layer are partially overlapped in a thickness direction of the ultrasonic fingerprint module, thereby reducing a thickness of the ultrasonic fingerprint module and facilitating thinning of the ultrasonic fingerprint module.

In addition, since the thickness of the body part in the first direction is greater than that of the extension part in the first direction, when the first portion is disposed on the extension part, a probability that the conductive particles in the ACF are not easily crushed by the pressing head due to being trapped in the first portion can be reduced.

In an implementation, the thickness of the first portion in the first direction is greater than or equal to that of the extension part in the first direction.

It can be understood that because the thickness of the first portion in the first direction is greater than or equal to the thickness of the extension part in the first direction, during bonding of the first pin to the first portion, the conductive particles of the ACF will be easily crushed by the pressing head because the conductive particles are not likely to be trapped in the first portion, thereby ensuring the electrical connection stability between the flexible circuit board and the electrode layer, and further ensuring connection reliability of the ultrasonic fingerprint module.

In an implementation, the electrode layer includes a main body part, a conductive part, and a connection part connected between the main body part and the conductive part. The main body part is disposed on a surface of the piezoelectric element away from the first surface. The connection part is disposed on a side surface of the piezoelectric element, the conductive part is disposed on the first surface, and the first portion is disposed on the conductive part.

In this implementation, the first pin of the flexible circuit board is electrically connected with the conductive part, so that the flexible circuit board, the electrode layer, and the piezoelectric element are partially overlapped in the thickness direction of the ultrasonic fingerprint module, thereby reducing the thickness of the ultrasonic fingerprint module and facilitating thinning of the ultrasonic fingerprint module.

In an implementation, the thickness of the first portion in the first direction is greater than or equal to that of the conductive part in the first direction. The first direction is a direction directed from the base plate to the piezoelectric element.

It can be understood that because the thickness of the first portion in the first direction is greater than or equal to the thickness of the conductive part in the first direction, during bonding of the first pin to the first portion, the conductive particles of the ACF will be easily crushed by the pressing head because the conductive particles are not likely to be trapped in the conductive part, thereby ensuring the electrical connection stability between the flexible circuit board and the electrode layer, and further ensuring connection reliability of the ultrasonic fingerprint module.

In an example, the electrode layer is made from silver.

In this example, because the silver is of a low price and is with a good conductivity, when the electrode layer is made from the silver, both the connection stability between the electrode layer and the flexible circuit board and a low cost of the ultrasonic fingerprint module can be ensured.

In an example, the ultrasonic fingerprint module includes a protective layer covering the surface of the electrode layer away from the piezoelectric element.

In this implementation, the protective layer is disposed on and covers the surface of the electrode layer away from the piezoelectric element to protect the electrode layer, and the electrode layer can be prevented from being damaged due to collision with other components, furthermore, the electrode layer can be prevented from being oxidized, thereby ensuring a reliable connection between the electrode layer and the piezoelectric element.

The electronic device provided in an implementation of the disclosure includes a housing, a display screen, and the ultrasonic fingerprint module described above. The display screen is mounted on the housing. The display screen and the housing define a device accommodation cavity. The ultrasonic fingerprint module is received in the device accommodation cavity. A top surface of the connection part of the ultrasonic fingerprint module faces the display screen.

In this implementation, the ultrasonic fingerprint module is disposed in the device accommodation cavity, so that when a user's finger is placed in a fingerprint collecting area of the display screen, the ultrasonic fingerprint module can accurately collect the user's fingerprint. In addition, because of the good electrical connection reliability of the ultrasonic fingerprint module, the electronic device also has a good reliability in the process of collecting the user's fingerprint.

### BRIEF DESCRIPTION OF THE DRAWINGS

In order to illustrate structural features and functions in this disclosure more clearly, the following detailed description will be made with reference to the drawings and specific implementations.

FIG. 1 is a schematic structural diagram of an electronic device according to implementations of the present disclosure.

FIG. 2 is a partial schematic cross-sectional view of the electronic device shown in FIG. 1 taken along the line M-M.

FIG. 3 is a schematic cross-sectional view of an ultrasonic fingerprint module of the electronic device shown in FIG. 2 according to implementations of the present disclosure.

FIG. 4 is a schematic structural diagram of a flexible circuit board of the ultrasonic fingerprint module shown in FIG. 3.

FIG. 5 is an enlarged schematic diagram of the flexible circuit board shown in FIG. 4 at area A according to implementations of the present disclosure.

FIG. 6 is an enlarged schematic diagram of the ultrasonic fingerprint module shown in FIG. 3 at area B.

FIG. 7 is an enlarged schematic diagram of the ultrasonic fingerprint module shown in FIG. 3 at area C.

FIG. 8 is an enlarged schematic diagram of the flexible circuit board shown in FIG. 4 at area A according to other implementations of the present disclosure.

FIG. 9 is a schematic cross-sectional view of an ultrasonic fingerprint module of the electronic device shown in FIG. 2 according to other implementations of the present disclosure.

### DETAILED DESCRIPTION

Technical solutions of implementations will be described clearly and completely with reference to accompanying drawings in the implementations. Apparently, implementations hereinafter described are merely some implementations, rather than all implementations, of the disclosure. All other implementations obtained by those of ordinary skill in the art based on the implementations herein without creative efforts shall fall within the protection scope of the disclosure.

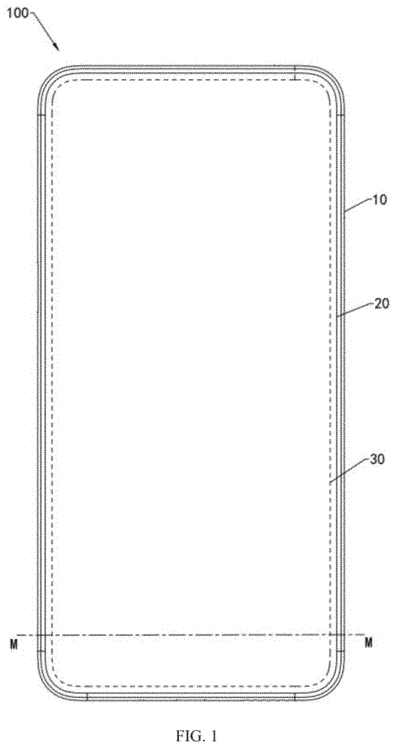

FIG. 1 is a structural diagram of an electronic device 100 according to implementations of the present disclosure. The electronic device 100 may include a smart device such as a tablet computer, a mobile phone, a camera, a personal computer, a notebook computer, an on-board device, an entrance gate, a wearable device, or the like. The electronic device 100 in implementations shown in FIG. 1 is illustrated by taking the mobile phone as an example.

As illustrated in FIG. 1, the electronic device 100 includes a housing 10, a display screen 20 and an ultrasonic fingerprint module 30. The display screen 20 is configured for displaying electronic images. The display screen 20 may be, but is not limited to, a liquid crystal display (LCD) screen or an organic light-emitting diode (OLED) display screen. In addition, the display screen 20 may be a rigid screen or a flexible screen. The display screen 20 can also be used as a touch screen, that is, the user can operate application software displayed in the display screen 20 by touching the display screen 20.

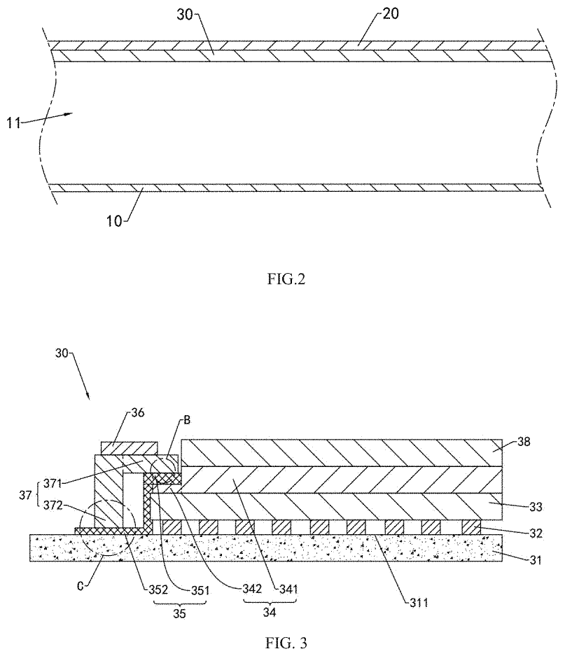

Reference is made to FIG. 2 in combination with FIG. 1, the display screen 20 is installed in the housing 10. The display screen 20 is usually of a plate structure, and the housing 10 is usually an accommodation structure with an upper end opened. The display screen 20 and the housing 10 enclose a device accommodation cavity 11 for accommodating related components of the mobile phone, such as an earpiece, a speaker, a camera, or a battery. In an example, a circumferential side surface of the display screen 20 abuts against an inner side of the housing 10 corresponding to an opening position and is connected with the housing 10 by glue. In this way, the housing 10 can effectively protect the display screen 20. Furthermore, the ultrasonic fingerprint module 30 is disposed in the device accommodation cavity 11. In order to better illustrate a position of the ultrasonic fingerprint module 30 in the electronic device 100, a dashed line is drawn in FIG. 1 to roughly illustrate the ultrasonic fingerprint module 30. However, a size and position of the ultrasonic fingerprint module 30 are not limited to those shown in FIG. 1. For example, the ultrasonic fingerprint module 30 can cover across a display part of the display screen 20 or the ultrasonic fingerprint module 30 can cover part of the display screen 20.

Reference is made to FIG. 2 again, in an example, the ultrasonic fingerprint module 30 is adhered to an inner surface of the display screen 20. In this way, the ultrasonic fingerprint module 30 can collect fingerprints at a position corresponding to the ultrasonic fingerprint module 30 on display portion of the display screen 20. Specifically, when a user's finger is placed at a position corresponding to the ultrasonic fingerprint module 30 on the display screen 20, the ultrasonic fingerprint module 30 emits an ultrasonic wave, which passes through the display screen 20 and is projected onto the user's finger. The ultrasonic wave is reflected at the user's fingerprint, returns to the ultrasonic fingerprint module 30, and is received by the ultrasonic fingerprint module 30. The ultrasonic fingerprint module 30 converts the received ultrasonic wave into an electrical signal so as to collect the user's fingerprint. Because fingerprints of a finger have a difference between a ridge and a valley, the ultrasonic waves reflected by the ridge and the valley of the fingerprint are different, that is, the electrical signals formed by the ultrasonic fingerprint module 30 according to the collected ultrasonic waves are also different. Therefore, the ultrasonic fingerprint module 30 collects the user's fingerprints according to the converted different electrical signals.

In an example, the ultrasonic fingerprint module 30 can compare the collected fingerprints with standard fingerprints stored in the database. The standard fingerprints refer to correct fingerprints stored by the user in the database in advance. A controller (not shown in FIG. 2) is provided in a device accommodation cavity 11. The controller may be a central processing unit (CPU) of the electronic device 100. The controller is electrically connected with the ultrasonic fingerprint module 30. In this way, the ultrasonic fingerprint module 30 can send a comparison result to the controller. The controller controls whether to start the display screen 20 according to the comparison result. For example, when the fingerprints collected by the ultrasonic fingerprint module 30 matches the standard fingerprints, the ultrasonic fingerprint module 30 sends the comparison result to the controller. The control controls the display screen 20 to be started. When the fingerprints collected by the ultrasonic fingerprint module 30 does not match the standard fingerprints, the ultrasonic fingerprint module 30 sends the comparison result to the controller. The controller controls the display screen 20 not to be started. In other implementations, the ultrasonic fingerprint module 30 can collect feature information of the user's fingerprint. In this way, the ultrasonic fingerprint module 30 collects the feature information of the user's fingerprint, and compares the feature information of the user's fingerprint collected with standard feature information in the database.

Reference is made to FIG. 3 in combination with FIG. 2, the ultrasonic fingerprint module 30 includes a base plate 31, multiple pixel electrodes 32, a piezoelectric element 33, an electrode layer 34, an ACF 35, a fingerprint chip 36, and a flexible circuit board 37.

The base plate 31 has a first surface 311. The base plate 31 can be, but is not limited to, made from glass or a polyimide film. A shape of the base plate 31 is adapted to that of the display screen 20. The base plate 31 made from glass or a polyimide film has advantages of low cost and good light transmittance. Therefore, the ultrasonic fingerprint module 30 (e.g., ultrasonic sensor 30) made of the base plate 31 also has the advantages of low cost and good light transmittance. When the ultrasonic sensor 30 is integrated in the display screen 20, the ultrasonic sensor 30 with a good light transmittance will not block display of the display screen 20.

The multiple pixel electrodes 32 are disposed on the first surface 311. The multiple pixel electrodes 2 are distributed in an array. The pixel electrode 32 can be, but is not limited to, made from any one of Indium tin oxide (ITO), silver nanowire (e.g., Ag nanowire), metal mesh, carbon nanotube, and Graphene. In this way, the pixel electrode 32 has a good flexibility and light transmittance, that is, the ultrasonic sensor 30 has a good flexibility and light transmittance.

The piezoelectric element 33 is disposed on surfaces of the multiple pixel electrodes 32 away from the first surface 311 and covers the multiple pixel electrodes 32. The piezoelectric element 32 is made from piezoelectric material. The piezoelectric element 32 transmits and receives the ultrasonic wave with piezoelectric effect. The piezoelectric material can be, but is not limited to, polyvinylidene fluoride (PVDF). Because PVDF has a good flexibility and light transmittance, the piezoelectric element 33 also has a good flexibility and light transmittance. In this way, the ultrasonic sensor 30 also has a good flexibility and light transmittance.

The electrode layer 34 is at least partially disposed on a surface of the piezoelectric element 33 away from the first surface 311. The electrode layer 34 covers the surface of the piezoelectric element 33 away from the first surface 311. In an example, the electrode layer 34 is made from silver. Because the silver is of a low price and is with a good conductivity, when the electrode layer 34 is made from the silver, both the connection stability between the electrode layer 34 and the flexible circuit board 37 and a low cost of the ultrasonic fingerprint can be ensured.

The ACF 35 includes a first portion 351 and a second portion 352 connected with the first portion 351. The first portion 351 is disposed on the electrode layer 34. The second portion 352 is partially disposed on the first surface 311. The second part 352 is partially disposed on a side surface of the piezoelectric element 33. The ACF 35 has conductive particles therein. When the conductive particles are broken under pressing by the pressing head, the conductive particles can electrically connect two components in a force application direction.

The flexible circuit board 37 includes a first connection area 371 and a second connection area 372 connected with the first connection area 371. The first connection area 371 is electrically connected with the electrode layer 34 through the first portion 351. The second connection area 372 is electrically connected with the multiple pixel electrodes 32 through the second portion 352. The ACF 35 can electrically connect the two components in the force application direction, so a short circuit the multiple pixel electrodes 32 can be avoided with the ACF 35. In an example, the flexible circuit board 37 may be disposed on a side of the base plate 31 away from the pixel electrodes 32. In addition, in another example, the flexible circuit board 37 is provided with a connector so that the ultrasonic sensor 30 can be electrically connected with other electronic components through the connector of the flexible circuit board 37.

The fingerprint chip 36 is mounted on the flexible circuit board 37. The fingerprint chip 36 can be configured to control a voltage across the piezoelectric element 33. For example, the fingerprint chip 36 can control the electrode layer 34 to communicate with a high-frequency voltage, and the pixel electrodes 32 to be grounded. In this way, when the high-frequency voltage is applied to the piezoelectric element 33, the piezoelectric element 33 generates and emits ultrasonic waves outward. In addition, the fingerprint chip 36 is also configured to receive a piezoelectric signal generated by the piezoelectric element 33 and form an ultrasonic image of an object to be detected according to the received electrical signal.

It can be seen from the above that the multiple pixel electrodes 32, the piezoelectric element 33, the electrode layer 34, the ACF 35, the flexible circuit board 37, and the fingerprint chip 36 constitute a closed loop of the ultrasonic fingerprint module 30. In this way, the ultrasonic fingerprint module 30 can collect fingerprints as follows.

When a user places a finger on the display screen 20, the fingerprint chip 36 outputs an electrical signal. The electrical signal is transmitted to the piezoelectric element 33 through the electrode layer 34 and the multiple pixel electrodes 32. The piezoelectric element 33 generates the ultrasonic waves upon application of the electrical signal. After the ultrasonic wave penetrates the display screen 20, it propagates to the finger of the user and is reflected by the finger with fingerprints. At this time, the piezoelectric element 33 converts the received ultrasonic waves into an electrical signal, and transmits the electrical signal to the fingerprint chip 36 through the electrode layer 34 and the multiple pixel electrodes 32. Finally, after the fingerprint chip 36 receives the electric signal, the user's fingerprint can be recognized according to the received electric signal. Locations of a fingerprint ridge and a fingerprint valley can be distinguished due to a difference in acoustic impedance caused by skin and air. In this way, according to a difference between the reflected ultrasonic waves, the user's fingerprint can be collected.

In an example, as illustrated in FIG. 3, the ultrasonic fingerprint module 30 includes a protective layer 38. The protective layer 38 can be, but is not limited to, made from an optically clear adhesive. The protective layer 38 is disposed on a surface of the electrode layer 34 away from the piezoelectric element 33 and covers the surface of the electrode layer 34 away from the piezoelectric element 33. The protective layer 38 can also be configured to adhere to the display screen 20 to stably fix the ultrasonic fingerprint module 30. In this example, the protective layer 38 is disposed on and covers the surface of the electrode 34 layer away from the piezoelectric element 33, the electrode layer 34 can be effectively protected, that is, the electrode layer 34 can be prevented from being damaged due to collision with other components, and also the electrode layer 34 can be prevented from being oxidized, thereby ensuring a reliable connection between the electrode layer 34 and the piezoelectric element 33.

As illustrated in FIG. 3, the electrode layer 34 includes a body part 341 and an extension part 342 connected with the body part 341. A thickness of the body part 341 in a first direction is greater than a thickness of the extension part 342 in the first direction. The first direction is a direction directed from the base plate 31 to the piezoelectric element 33. The first portion 351 is disposed on the extension part 342.

In this implementation, a first pin 374 of the flexible circuit board 37 is electrically connected with the extension part 342, so that the flexible circuit board 37 and the electrode layer 34 are partially overlapped in a thickness direction of the ultrasonic fingerprint module 30, thereby reducing a thickness of the ultrasonic fingerprint module 30 and facilitating a thinning of the ultrasonic fingerprint module 30.

In addition, because the thickness of the body part 341 in the first direction is greater than that of the extension part 342 in the first direction, when the first portion 351 is disposed on the extension part 342, a probability that the conductive particles in the ACF 35 are not easily crushed by the pressing head due to being trapped in the first portion 351 can be reduced with the extension part 342.

In an implementation, the thickness of the first portion 351 in the first direction is greater than or equal to that of the extension part 342 in the first direction.

Because the thickness of the first portion 351 in the first direction is greater than or equal to the thickness of the extension part 342 in the first direction, during bonding of the first pin 374 to the first portion 351, the conductive particles of the ACF 35 will be easily crushed by the pressing head because the conductive particles are not likely to be trapped in the first portion 351, thereby ensuring the electrical connection stability between the flexible circuit board 37 and the electrode layer 34, and further ensuring the excellent connection reliability of the ultrasonic fingerprint module 30.

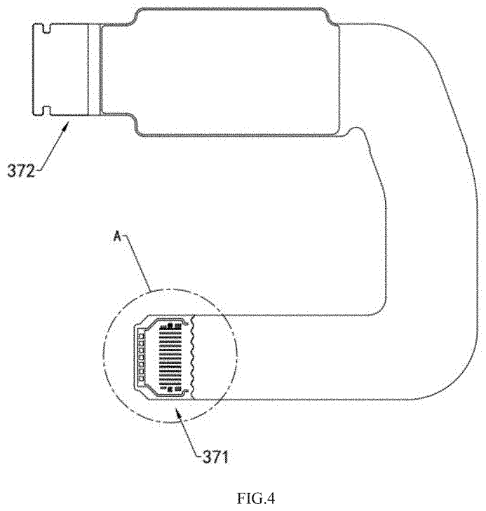

As illustrated in FIGS. 4 to 7, the flexible circuit board 37 includes a substrate 373, one first pin 374, and multiple second pins 375.

The substrate 373 can be, but is not limited to, of polymethyl methacrylate (PMMA).

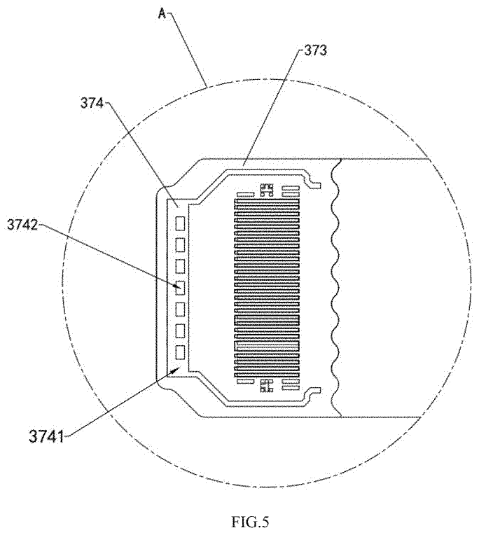

As illustrated in FIGS. 5 to 4, the first pin 374 is disposed in the first connection area 371. In addition, reference is made to FIG. 6 in combination with FIG. 5, the first pin 374 has a first connection surface 3741 away from the substrate 373. The first connection surface 3741 is attached to the first portion 351. In addition, the first pin 374 defines an accommodation space 3742. The accommodation space 3742 has an opening on the first connection surface 3741. The first portion 351 is partially received in the accommodation space 3742. The first pin 374 is electrically connected with the electrode layer 34 through the first portion 351. The first pin 374 is electrically connected with the electrode layer 34 through broken conductive particles.

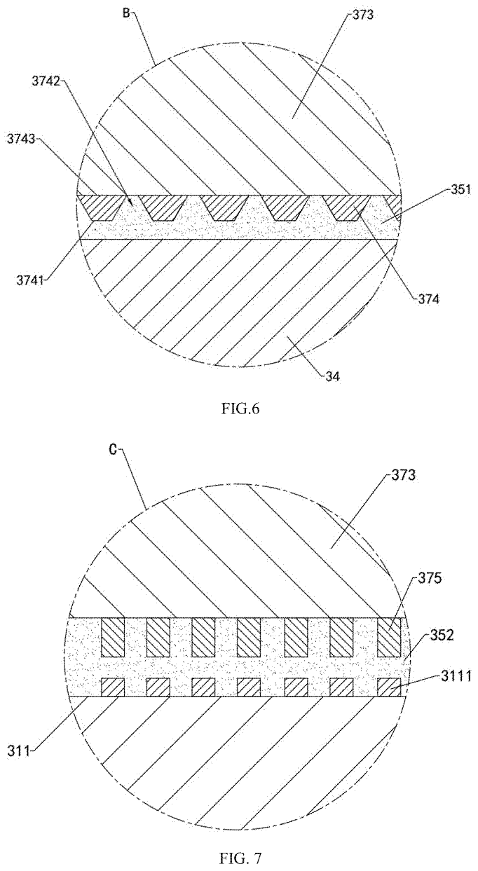

As illustrated in FIG. 7 in combination with FIG. 4, the multiple second pins 375 are disposed in the second connection area 372. reference is made to FIG. 7 in combination with FIG. 3, the multiple second pins 375 are disposed in the second portion 352 and electrically connected with the multiple pixel electrodes 32 through the second portion 352. In an example, multiple metal pins 3111 are disposed on the first surface 311. The multiple metal pins 3111 are electrically connected with the multiple pixel electrodes 32. In this way, the multiple second pins 375 and the multiple metal pins 3111 are electrically connected with each other through the second portion 352 in one-to-one correspondence. The ACF 35 can electrically connect two components in a force application direction, and thus a short circuit between the multiple second pins 375 or between the multiple metal pins 3111 can be avoided with the ACF 35.

In addition, as illustrated in FIGS. 3 to 7, the fingerprint chip 36 is electrically connected between the first pin 374 and the multiple second pins 375, that is, the fingerprint chip 36 applies the electrical signal to the piezoelectric element 33 through the first pin 374 and the multiple second pins 375, or receives the electrical signal from the piezoelectric element 33 through the first pin 374 and the multiple second pins 375.

In this implementation, by defining the accommodation space 3742 in the first pin 374, part of the ACF 35 can be filled into the accommodation space 3742 during bonding of the first pin 374 to the electrode layer 34. In this way, the ACF 35 formed between the first connection surface 3741 and the electrode layer 34 has a small thickness, thus ensuring that conductive particles in the ACF 35 can be electrically connected with both the first pin 374 and the electrode layer 34 at the same time, and further ensuring the electrical connection stability between the first pin 374 and the first portion 351.

In addition, when the ACF 35 between the first connection surface 3741 and the electrode layer 34 has a small thickness, no gap will be generated between the flexible circuit board 37 and the electrode layer 34, thus ensuring that no external water vapor or air will enter this gap.

In addition, by defining the accommodation space 3742 in the first pin 374, a contact area between the first pin 374 and the first portion 351 is increased, so that the electrical connection stability between the first pin 374 and the first portion 351 is improved.

Reference can be made to FIG. 6 in combination with FIG. 3, the first pin 374 has a second connection surface 3743. The second connection surface 3743 is disposed opposite to the first connection surface 3741. The accommodation space 3742 extends through the second connection surface 3743. In this way, the accommodation space 3742 has a large volume so that more ACF 35 can be accommodated in the accommodation space 3742 during bonding of the first pin 374 to the electrode layer 34, thereby reducing the thickness of the ACF 35 between the first connection surface 3741 and the electrode layer 34, and ensuring that the conductive particles in the ACF 35 can be electrically connected to the first pin 374 and the electrode layer 34 at the same time.

Reference can be made to FIG. 8 in combination with FIG. 6, the first pin 374 has a circumferential side surface 3744. The circumferential side surface 3744 is connected between the first connection surface 3741 and the second connection surface 3743. The accommodation space 3742 extends through at least part of the circumferential side surface 3744, that is, the circumferential side surface 3744 has an opening of the accommodation space 3742. In this way, when the first pin 374 is bonded to the first portion 351, part of the ACF 35 can flow out in a direction away from the first pin 374 through the opening of the circumferential side surface 3744, thereby further reducing the thickness of the ACF 35 disposed between the first connection surface 3741 and the electrode layer 34.

In an implementation, the accommodation space 3742 has a planar groove side wall. The groove side wall has an included angle relative to the first connection surface 3741. The included angle is greater than 90°. In this way, compared with an included angle being equal to 90°, in this implementation, the included angle is set to be greater than 90° so that a surface area of the groove side wall of the accommodation space 3742 is larger. Therefore, on one hand, during bonding of the first pin 374 to the electrode layer 34, more ACF 35 can be accommodated in the accommodation space 3742, thereby reducing the thickness of the ACF 35 disposed between the first connection surface 3741 and the electrode layer 34, and on the other hand, the contact area between the first pin 374 and the first portion 351 is increased, thereby improving the electrical connection stability between the first pin 374 and the first portion 351.

In addition, compared with an included angle being less than or equal to 90°, in this implementation, by setting the included angle being greater than 90°, a process difficulty in preparing the accommodation space 3742 at the first pin 374 can be reduced.

In an implementation, the accommodation space 3742 has a cambered groove side wall, and the cambered groove side wall is concave in a direction away from a center of the accommodation space 3742. In this way, the surface area of the groove side wall of the accommodation space 3742 is larger. Therefore, on one hand, during bonding of the first pin 374 of the flexible circuit board 37 to the electrode layer 34, more ACF 35 can be accommodated in the accommodation space 3742, thereby reducing the thickness of the ACF 35 disposed between the first connection surface 3741 and the electrode layer 34, and on the other hand, the contact area between the first pin 374 and the first portion 351 is increased, thereby improving the electrical connection stability between the first pin 374 and the first portion 351.

In an implementation, reference can be made to FIGS. 5 to 8 again, the accommodation space 3742 has multiple accommodation spaces arranged in an array. In this way, the accommodation space 3742 has a large total volume, that is, more ACF 35 can be accommodated in the accommodation space 3742, thereby reducing the thickness of the ACF 35 between the first connection surface 3741 and the electrode layer 34. In addition, the contact area between the first pin 374 and the first portion 351 can also be increased, thereby improving the electrical connection stability between the first pin 374 and the first portion 351.

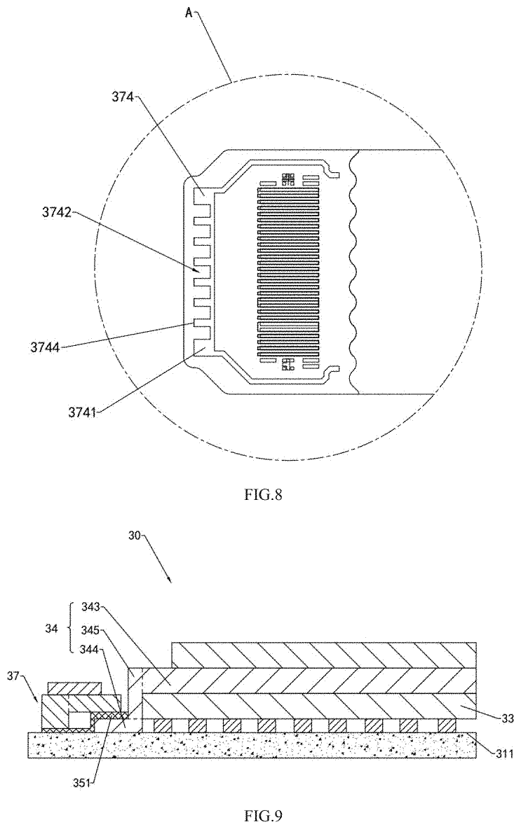

Reference can be made to FIG. 9 in combination with FIG. 5, the electrode layer 34 includes a main body part 343, a conductive part 344 and a connection part 345 connected between the main body part 343 and the conductive part 344. The main body part 343 is disposed on a surface of the piezoelectric element 33 away from the first surface 311. The connection part 345 is disposed on a side surface of the piezoelectric element 33, the conductive part 344 is disposed on the first surface 311, and the first portion 344 is disposed on the conductive part 351.

In this implementation, the conductive part 344 is disposed on the first surface 311, and the first pin 374 of the flexible circuit board 37 is electrically connected with the conductive part 344, so that the flexible circuit board 37, the electrode layer 34 and the piezoelectric element 33 are partially overlapped in a thickness direction of the ultrasonic fingerprint module 30, thereby reducing a thickness of the ultrasonic fingerprint module 30 and facilitating a thinning of the ultrasonic fingerprint module.

In an implementation, the thickness of the first portion 351 in the first direction is greater than or equal to that of the conductive part 344 in the first direction. The first direction is a direction directed from the base plate 31 to the piezoelectric element 33.

It can be understood that because the thickness of the first portion 351 in the first direction is greater than or equal to the thickness of the conductive part 344 in the first direction, during bonding of the first pin 374 to the first portion 344, the conductive particles of the ACF 35 will be easily crushed by the pressing head because the conductive particles are not likely to be trapped in the conductive part 344, thereby ensuring the electrical connection stability between the flexible circuit board 37 and the electrode layer 34, and further ensuring the excellent connection reliability of the ultrasonic fingerprint module 30.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A flexible circuit board, comprising:
a substrate comprising a first connection area and a second connection area connected with the first connection area;
one first pin disposed in the first connection area and having a first connection surface away from the substrate, the first pin defining an accommodation space, and the accommodation space having an opening on the first connection surface; and
a plurality of second pins disposed in the second connection area.

2. The flexible circuit board of claim 1, wherein the first pin has a second connection surface opposite to the first connection surface, and the accommodation space extends through the second connection surface.

3. The flexible circuit board of claim 2, wherein the first pin has a circumferential side surface connected between the first connection surface and the second connection surface, and the accommodation space extends through at least part of the circumferential side surface.

4. The flexible circuit board of claim 1, wherein the accommodation space has a planar groove side wall, the planar groove side wall has an included angle relative to the first connection surface, and the included angle is greater than 90°.

5. The flexible circuit board of claim 1, wherein the accommodation space has a cambered groove side wall, and the cambered groove side wall is concave in a direction away from a center of the accommodation space.

6. The flexible circuit board of claim 1, wherein the accommodation space has a plurality of accommodation spaces arranged in an array.

7. An ultrasonic fingerprint module, comprising:
a base plate having a first surface;
a plurality of pixel electrodes disposed on the first surface;
a piezoelectric element disposed on surfaces of the plurality of pixel electrodes away from the first surface and covering the plurality of pixel electrodes;
an electrode layer at least partially disposed on a surface of the piezoelectric element away from the first surface;
an anisotropic conductive adhesive comprising a first portion and a second portion connected with the first portion, the first portion being disposed on the electrode layer and the second portion being partially disposed on the first surface;
a flexible circuit board, wherein the flexible circuit board comprises: a substrate comprising a first connection area and a second connection area connected with the first connection area; one first pin disposed in the first connection area and having a first connection surface away from the substrate, the first pin defining an accommodation space, and the accommodation space having an opening on the first connection surface; and a plurality of second pins disposed in the second connection area; wherein the first connection surface is attached to the first portion, the first portion is partially received in the accommodation space, the first pin is electrically connected with the electrode layer through the first portion, and the plurality of second pins are disposed in the second portion and electrically connected with the plurality of pixel electrodes through the second portion; and
a fingerprint chip mounted on the flexible circuit board and electrically connected between the first pin and the second pins.

8. The ultrasonic fingerprint module of claim 7, wherein the first pin has a second connection surface opposite to the first connection surface, and the accommodation space extends through the second connection surface.

9. The ultrasonic fingerprint module of claim 8, wherein the first pin has a circumferential side surface connected between the first connection surface and the second connection surface, and the accommodation space extends through at least part of the circumferential side surface.

10. The ultrasonic fingerprint module of claim 7, wherein the accommodation space has a planar groove side wall, the planar groove side wall has an included angle relative to the first connection surface, and the included angle is greater than 90°.

11. The ultrasonic fingerprint module of claim 7, wherein the accommodation space has a cambered groove side wall, and the cambered groove side wall is concave in a direction away from a center of the accommodation space.

12. The ultrasonic fingerprint module of claim 7, wherein the accommodation space has a plurality of accommodation spaces arranged in an array.

13. The ultrasonic fingerprint module of claim 7, wherein the electrode layer comprises a body part and an extension part connected with the body part, the thickness of the body part in a first direction is larger than that of the extension part in the first direction, the first direction is a direction directed from the base plate to the piezoelectric element, and the first portion is disposed on the extension part.

14. The ultrasonic fingerprint module of claim 8, wherein the thickness of the first portion in the first direction is greater than or equal to that of the extending part in the first direction.

15. The ultrasonic fingerprint module of claim 7, wherein the electrode layer comprises a main body part, a conductive part, and a connection part connected between the main body part and the conductive part, wherein the main body part is disposed on a surface of the piezoelectric element away from the first surface, the connection part is disposed on a side surface of the piezoelectric element, the conductive part is disposed on the first surface, and the first portion is disposed on the conductive part.

16. The ultrasonic fingerprint module of claim 15, wherein the thickness of the first portion in a first direction is greater than or equal to that of the conductive part in the first direction, and the first direction is a direction directed from the base plate to the piezoelectric element.

17. The ultrasonic fingerprint module of claim 7, further comprising:
a protective layer covering a surface of the electrode layer away from the piezoelectric element.

18. An electronic device, comprising a housing, a display screen, and an ultrasonic fingerprint module, wherein the display screen is mounted on the housing, the display screen and the housing define a device accommodation cavity, the ultrasonic fingerprint module is received in the device accommodation cavity; wherein the ultrasonic fingerprint module comprises:
a base plate having a first surface, wherein the first surface of the ultrasonic fingerprint module towards the display screen;
a plurality of pixel electrodes disposed on the first surface;
a piezoelectric element disposed on surfaces of the plurality of pixel electrodes away from the first surface and covering the plurality of pixel electrodes;
an electrode layer at least partially disposed on a surface of the piezoelectric element away from the first surface;
an anisotropic conductive adhesive comprising a first portion and a second portion connected with the first portion, the first portion being disposed on the electrode layer and the second portion being partially disposed on the first surface;
a flexible circuit board, wherein the flexible circuit board comprises: a substrate comprising a first connection area and a second connection area connected with the first connection area; one first pin disposed in the first connection area and having a first connection surface away from the substrate, the first pin defining an accommodation space, and the accommodation space having an opening on the first connection surface; and a plurality of second pins disposed in the second connection area; wherein the first connection surface is attached to the first portion, the first portion is partially received in the accommodation space, the first pin is electrically connected with the electrode layer through the first portion, and the plurality of second pins are disposed in the second portion and electrically connected with the plurality of pixel electrodes through the second portion; and
a fingerprint chip mounted on the flexible circuit board and electrically connected between the first pin and the second pins.

19. The electronic device of claim 18, wherein the electrode layer comprises a body part and an extension part connected with the body part, the thickness of the body part in a first direction is larger than that of the extension part in the first direction, the first direction is a direction directed from the base plate to the piezoelectric element, and the first portion is disposed on the extension part.

20. The electronic device of claim 18, wherein the electrode layer comprises a main body part, a conductive part, and a connection part connected between the main body part and the conductive part, wherein the main body part is disposed on a surface of the piezoelectric element away from the first surface, the connection part is disposed on a side surface of the piezoelectric element, the conductive part is disposed on the first surface, and the first portion is disposed on the conductive part.
